(19) United States
(12) Patent Application Publication
(10) Pub. No.: US 2018/0011821 A1
(43) Pub. Date: Jan. 11, 2018

(54) PRESENTATION SYSTEM, RECEIVER DEVICE, METHODS THEREOF, AND NON-TRANSITORY COMPUTER-READABLE MEDIUM THEREOF

(71) Applicant: Barco Limited, New Taipei City (TW)

(72) Inventors: Hsing-Yung WANG, Taoyuan City (TW); Jr-Rong FAN, New Taipei City (TW)

(21) Appl. No.: 15/703,118

(22) Filed: Sep. 13, 2017

Related U.S. Application Data
(63) Continuation-in-part of application No. 13/886,863, filed on May 3, 2013, now abandoned.

(30) Foreign Application Priority Data
May 4, 2012 (TW) 101115965

(51) Int. Cl. G06F 17/22; G06F 3/14

(52) U.S. Cl. CPC G06F 17/22; G06F 3/1454

(57) ABSTRACT

A presentation method comprises: a sender device capturing screen frames and transmitting the screen frames to a receiver device; the receiver device receiving the screen frames transmitted by the sender device and outputting the screen frames to a display device for displaying the screen frames; establishing a webpage server in the receiver device; and the receiver device storing the screen frames as web pages. Thereby, the audiences can use the browsers of mobile Internet devices to link with the webpage server and browse the web pages containing the presentation contents.

### CROSS-REFERENCE TO RELATED APPLICATION

This is a continuation-in-part of U.S. patent application Ser. No. 13/886,863, filed in May 3, 2013, for which priority is claimed under 35 U.S.C. §120; and this application claims priority of Application No. 101115965 filed in TAIWAN on May 4, 2012 under 35 U.S.C. §119, the entire contents of all of which are hereby incorporated by reference.

### BACKGROUND OF THE INVENTION

### 1. Field of the Invention

The present invention relates to a presentation system, a receiver device and methods thereof, particularly to a presentation system, a receiver device and methods thereof, wherein the user can use a browser to view the web pages containing the presentation contents.

### 2. Description of the Prior Art

The conventional presentation system captures the screen frames of presentation pages, which is to be presented, and transmits the captured screen frames to a display device, such as a projector or a television. Then, the display device presents the presentation pages to the audiences. In a large-scale presentation occasion, the audiences do not necessarily view the presentation contents clearly because of poor image quality of the projector, insufficient resolution of the display device, and/or too long a distance between the audiences and the screen.

Recently, mobile internet devices (MID), such as smart phones and tablet computers, have been popularized very fast. Therefore, it has become a target the manufacturers are eager to achieve that the audiences can use MID or other network devices having a display to view the presentation contents.

### SUMMARY OF THE INVENTION

The present invention is directed to a presentation system, a receiver device, methods thereof and a non-transitory computer-readable medium thereof, wherein the sender side transmits the screen frames to the receiver side, and wherein the receiver side stores the screen frames as web pages, and wherein a webpage server is established in the receiver side for the mobile Internet devices or other network devices of the audiences attending the presentation to link, whereby the audiences can view the web pages containing the presentation contents.

In first embodiment, the proposed presentation system includes a sender device and a receiver device. The sender device includes a capture module and a first communication interface. The capture module is configured for capturing lossless screen frames from the sender device undertaking a presentation through a software program. The first communication interface electrically connects with the capture module and is configured for transmitting the screen frames captured by the capture module. The receiver device includes a second communication interface, a video connection port, a webpage server, and a network interface. The second communication interface is configured for receiving the screen frames transmitted by the sender device. The video connection port is configured for electrically connecting with a display device. The received screen frames are output to the display device via the video connection port and presented on the display device to display said screen frames for audiences. The webpage server is established in the receiver device and stores the received screen frames in a static picture format as web pages. The network interface electrically connects with the webpage server, so that a browser can link to the webpage server via the network interface for browsing the web pages of the webpage server, wherein the first communication interface, the second communication interface and the network interface abide by IEEE 802.11 wireless communication standard series.

In second embodiment, the proposed receiver device, which cooperates with a sender device to form a presentation system. The sender device captures lossless screen frames from the sender device undertaking a presentation through a software program and transmits the captured screen frames to the receiver device. The receiver device includes a communication interface, a video connection port, a webpage server, and a network interface. The communication interface is configured for receiving the screen frames transmitted by the sender device. The video connection port is configured for electrically connecting with a display device. The received screen frames are output to the display device via the video connection port and presented on the display device. The webpage server is established in the receiver device and stores the received screen frames in a static picture format as web pages. The network interface electrically connects with the webpage server, so that a browser can link to the webpage server via the network interface for browsing the web pages of the webpage server during presenting, wherein the communication interface and the network interface abide by IEEE 802.11 wireless communication standard series.

In third embodiment, the proposed presentation method comprises: a sender device capturing lossless screen frames from the sender device undertaking a presentation through a software program and transmitting the screen frames to a receiver device, wherein the sender device and the receiver device abide by IEEE 802.11 wireless communication standard series; the receiver device receiving the screen frames and outputting the screen frames to a display device for displaying the screen frames; establishing a webpage server in the receiver device; the receiver device storing the screen frames in a static picture format as web pages, which are to be browsed by a browser linked to the webpage server.

In fourth embodiment, the proposed method for displaying presentation contents comprises: a receiver device receiving screen frames captured by a sender device from the sender device undertaking a presentation through a software program and outputting the received screen frames to a display device for presenting the screen frames; establishing a webpage server in the receiver device; the receiver device storing the received screen frames in a static picture format as web pages, which are browsed by a browser linked to the webpage server during presenting.

In fifth embodiment, the proposed non-transitory computer-readable medium, which stores a computer program that is loaded into a receiver device to execute a method for displaying presentation contents, wherein the method for displaying presentation contents comprises: a receiver device receiving screen frames captured by a software program of a sender device from the sender device undertaking a presentation and outputting the received screen frames to a display device for presenting the screen frames; establishing a webpage server in the receiver device; the receiver device storing the received screen frames in a static picture format as web pages, which are browsed by a browser linked to the webpage server.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a block diagram schematically showing a presentation system according to one embodiment of the present invention;

FIG. 2 is a flowchart schematically showing a presentation method according to one embodiment of the present invention; and

FIG. 3 is a flowchart schematically showing a method for displaying presentation contents according to one embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

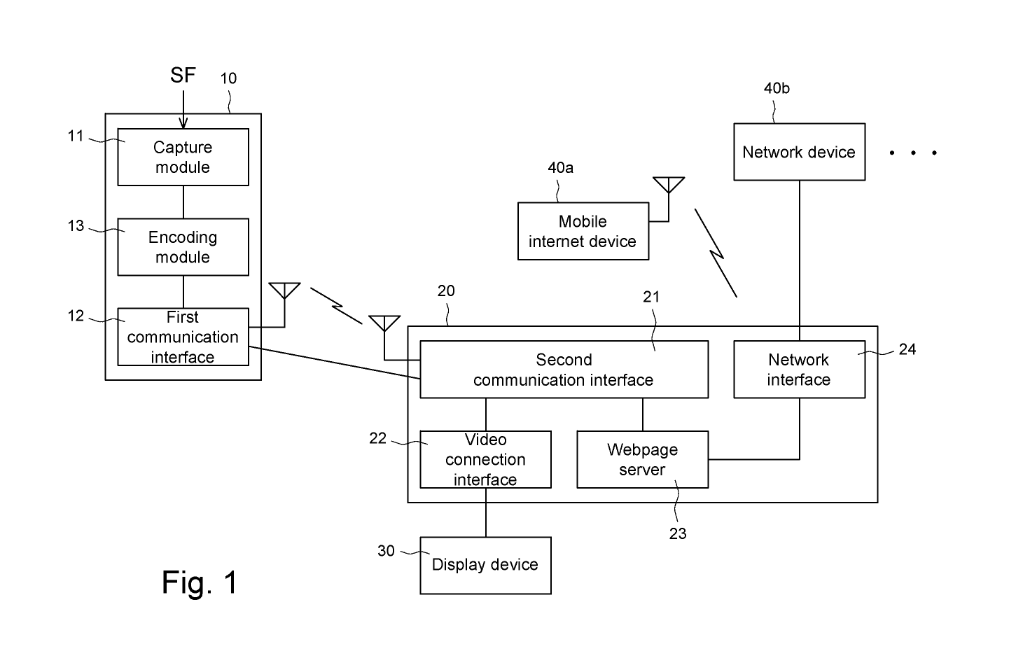

Refer to FIG. 1 a block diagram schematically showing a presentation system according to one embodiment of the present invention. The presentation system of the present invention comprises a sender device 10 and a receiver device 20. The sender device 10 includes a capture module 11 and a first communication interface 12. The capture module 11 captures screen frames SF of the sender device 10 itself. In one embodiment, the capture module 11 obtain lossless screen frames from a computer (i.e. the sender device 10) undertaking a presentation by the operating system through a software program. For example, the present application is to use the software program to directly capture/seize the digital data corresponding to the screen frame, i.e. screenshot command or “PrtScn” function.

In one embodiment, the sender device 10 further includes an encoding module 13 electrically connecting with the capture module 11 and the first communication interface 12. Owing to limitation in bandwidth, the encoding module 13 encodes the screen frames SF captured by the capture module 11 to reduce the data volume before data transmission. In one embodiment, the lossless screen frame captured by the capture module 11 is encoded into but not limit to BMP, JEPG, PNG or TIFF picture, which may be a lossy compression picture format.

In another embodiment, the capture module 11 could perform lossless capturing process, so that the audiences will be able to more clearly read the lossless screen frames of better image quality on a display device 30 or a mobile Internet device 40a. For example, the capture module 11 obtains screen frames from the sender device 10 through digital signal conversion. That is, the screen frame captured by the capture module 11 and the screen content displayed by the sender device 10 are both electrical signals and could be converted to each other through the digital signal format conversion. In another embodiment, the screen frame captured by the capture module 11 and the screen content displayed by the sender device 10 are the same in the signal format without the digital signal format conversion. Thus, the term “lossless screen frame” refers to the captured screen frame of the capture module 11 is exactly the same as the screen content displayed on the sender device 10 and the display device 30 (that is, displayed on the screen that the speaker sees), wherein the lossless screen frame is obtained without any signal conversion (for example, analog-to-digital conversion) during the capturing process undertaken by the software program.

In traditional capture module, the technical principle of video capture device (such as camera) is to use an image/light sensing element (such as CMOS component) that receives the image/ambient light to produce an analog signal and then convert the analog signal to a digital signals in circuits as digital image data, so the digital image data converted by camera is intrinsically a loss/distortion data. Therefore, when the optical signal is converted into the electrical signal, the conversion process is bound to lose some information. In other words, the digital data of the camera image is difficult to show the reality of the screen image without distortion. In addition, the video camera captured images are highly susceptible to changes in light. For example, some variables such as that the light caused by the dust in the air is reflected or refracted, the light is refracted by the change in the air density caused by the heat or moisture, or the limits of the dynamic range imaging of the image sensing element itself may degrade the image quality and definition of the captured image. In addition, due to the above factors, the captured image of the previous frame and the captured image of the next frame are difficult to be exactly the same; that is, it is difficult to be realized that every pixels is the same between adjacent screen frames.

The first communication interface 12 electrically connects with the capture module 11 and transmits the screen frames SF captured by the capture module 11 to the receiver device 20. For example, the first communication interface 12 may be a wired network interface or a wireless network interface. Preferably, the first communication interface 12 abides by IEEE 802.11 wireless communication standard series.

The receiver device 20 includes a second communication interface 21, a video connection port 22, a webpage server 23, and a network interface 24. The receiver device 20 is also called the presentation base unit, which functions like a set-top box (STB) of a digital TV. Generally, the receiver device 20 receives external signal sources to display the contents of the external signal sources on a display device except the frames for turning-on, turning-off, setting, etc. The second communication interface 21 works according to a communication protocol corresponding to the first communication interface 12 to receive the non-encoded (i.e., lossless) or encoded (i.e., lossy) screen frames SF transmitted by the sender device 10. The video connection port 22 electrically connects with a display device 30. The screen frames received by the second communication interface 21 is outputted through the video connection port 22 to the display device 30 and presented on the display device 30. It should be noted that the receiver device 20 may be built in the display device 30 or electrically connected with the display device 30 in a detachable way. For example, the video connection port 22 may be a VGA (Video Graphic Array) port, DVI (Digital Visual Interface), or HDMI (High Definition Multimedia Interface) etc.

In one embodiment, the screen frames received by the second communication interface 21 would be integrated as one split screen frame. For example, the split screen has four screen frames SF received from four sender devices. Further, the receiver device 20 would save the split screen frame in a static picture format as web pages as mentioned above. Therefore, the split screen is outputted through the video connection port 22 to the display device 30 and presented on the display device 30.

The webpage server 23 may store a screen frame as a web page. For example, a screen frame may be stored in a storage element, such as an RAM (Random Access Memory), a flash memory or a hard disc, of the receiver device 20, and a fixed access path is assigned to the screen frame. Thus, the webpage server 23 can retrieve the web page containing the screen frame according to the access path. In one embodiment, the screen frame is stored in a static picture format as the web page. For example, the static picture format may be BMP, JPEG, PNG, TIFF etc. The network interface 24 electrically connects with the webpage server 23. The audiences attending the presentation may use the browser of a mobile Internet device 40a (such as a smart phone or a tablet computer) or another network device 40b to establish a network link to the webpage server 23 through the network interface 24 so as to browse the web page containing the screen frame of the presentation. In one embodiment, the second communication interface 21 and the network interface 24 can be integrated together. For example, only a single WLAN (wireless Local Area Network) interface based on the IEEE 802.11 wireless communication standard series is sufficient to receive the screen frames SF sent out by the sender device 10 and the browsing request sent out by the mobile Internet device 40a or another network device 40b. As the webpage server 23 of the receiver device 20 storing the screen frames in a static picture format as web pages, the mobile Internet device 40a or network device 40b do not need to install application (such as to download media player application) or browser plug-in for real-time sharing. For example, neither video streaming protocol nor Flash plug-in would be required in the browser in light of the invention, so as to avoid the incompatible problems among different operating systems, such as Android operating system and iOS operating system, and to be audiences friendly.

According to the above framework, the host organization of presentation can provide the IP address of the webpage server 23 for the audiences at the entrances, beside the seats or on the presentation image. Then, the audiences can use the mobile Internet device 40a or another network device 40b including monitor to browse the presentation pages being displayed without installing any specified program. Thereby, although the speaker neither sets up a webpage server nor prepares the web pages of the presentation contents, the audiences can still browse the presentation contents synchronously.

In one embodiment, the sender device 10 can be programmed to determine whether the screen frames SF are released to the public or not. For example, if the speaker deems that it is unsuitable to issue the presentation contents to the public because of copyright or other factors, he can control the sender device 10 to generate a corresponding signal to prevent the screen frames from being stored as web pages by the receiver device 20.

In one embodiment, the sender device 10 captures and transmits screen frames SF periodically. For example, the sender device 10 captures and transmits screen frames SF for a period of 1, 3, 5, or 10 seconds or a long interval of time. In one embodiment, the sender device 10 transmits static screen frames SF aperiodically. For example, the sender device 10 captures screen frames SF periodically; if the screen frame does not change for a given period of time, the screen frame is defined as a static screen frame and transmitted to the receiver device 20. It is noted that it is guaranteed to view web pages in the static picture format by any browser without needed to install additional plug-in software or to download a media player application. Additionally, the web page is a static screen frame, so that the requirements of hardware resource of the webpage server (or the receiver device) can be reduced, which can effectively reduce the cost of the presentation system. If the screen frame of the computer is static or unchanged, i.e. the capture module 11 successively captures two screen frames and each bit of the two captured screen frames is identical to each other, the second communication interface 21 will not receive new captured screen for the webpage server 23 encoding into the static picture format as a web page. In one embodiment, the sender device 10 detects whether the captured screen frame changes; if the captured screen frame is changed (such as by changing the slide), the sender device 10 transmits the changed screen frame to the receiver device 20. In one embodiment, if the screen frame is changed only in some regions, the sender device 10 only transmits the changed regions to the receiver device 20; the receiver device 20 uses the changed regions to refresh the screen frame; then the receiver device 20 transmits the refreshed screen frame to the display device 30 or stores the refreshed screen frame as a web page.

In one embodiment, the webpage server 23 includes an automatic refresh module (not shown in the drawings). The automatic refresh module can automatically refresh the web page browsed by the user in the user side. For example, a refreshing period can be set in the web page. For example, the web page is refreshed per 30 second or per 60 seconds. Thus, the browser in the user side refreshes the web page being browsed by the user per 30 seconds or per 60 seconds. Alternatively, while the web page stored in the webpage server 23 is changed, the webpage server 23 actively refreshes the web page being browsed by the browser linked to the webpage server 23. That is, the webpage server 23 could automatically refresh the web pages browsed by the browser, so that the mobile Internet device 40a or network device 40b linked to the webpage server 23 do not need to install application or browser plug-in software to refresh the web pages for realizing real-time sharing. However, it is realized that the browser of the client side could also be refresh by JavaScript but not limited to the embodiments as set forth above.

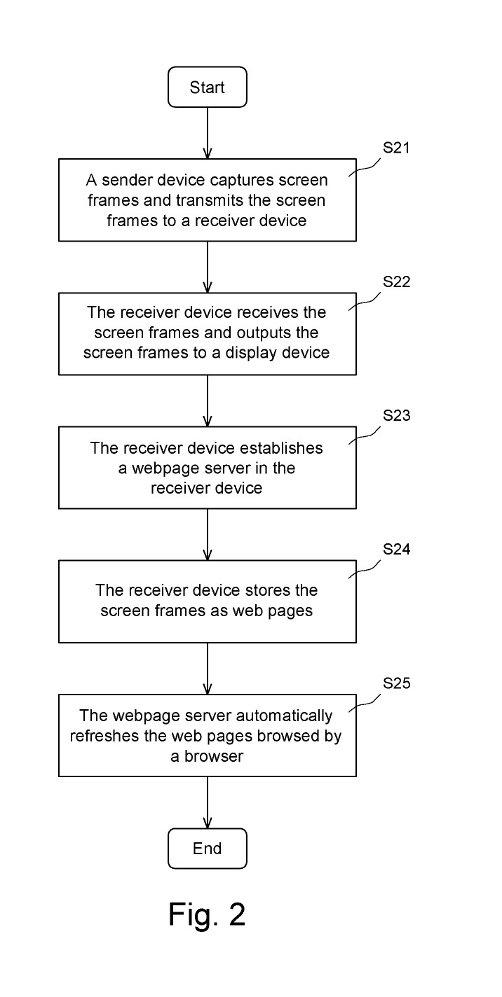

Below is described a presentation method according to one embodiment of the present invention. Refer to FIG. 1 and FIG. 2. Firstly, in Step S21, a sender device 10 captures a screen frame SF and transmits the screen frame SF to a receiver device 20. In Step S22, the receiver device 20 receives the screen frame SF transmitted by the sender device 20 and outputs the screen frame SF to a display device 30 for displaying the screen frame SF. In Step S23, a webpage server 23 is established in the receiver device 20. In Step S24, the receiver device 20 stores the screen frame transmitted by the sender device 10 as a web page, which can be browsed by a user-side browser linked to the webpage server 23. In one embodiment, the presentation method of the present invention further comprises Step S25: the webpage server 23 automatically refreshes the web page being browsed by the browser, which has been described hereinbefore and will not repeat herein.

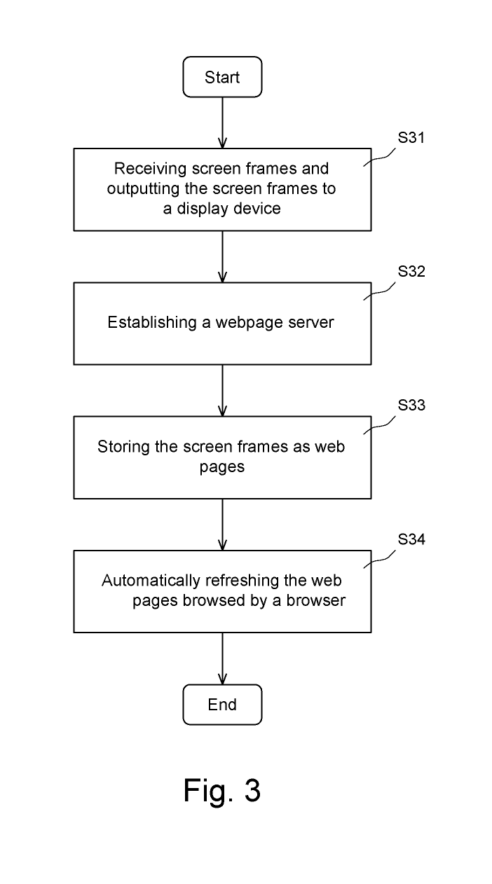

Below is described a method for displaying presentation contents, which is applied to a receiver device. Refer to FIG. 1 and FIG. 3. Firstly, in Step S31, a receiver device 20 receives a screen frame SF captured by a sender device 10 and outputs the screen frame SF to a display device 30 for displaying the screen frame SF. In Step S32, a webpage server 23 is established in the receiver device 20. In Step S33, the receiver device 20 stores the screen frame SF transmitted by the sender device 10 as a web page, which can be browsed by a user-side browser linked to the webpage server 23. In one embodiment, the method for displaying presentation contents of the present invention further comprises Step S34: the webpage server 23 automatically refreshes the web page being browsed by the browser, which has been described hereinbefore and will not repeat herein.

The present invention also discloses a non-transitory computer-readable medium. The non-transitory computer-readable medium stores a computer program, which can be loaded into a receiver device to execute the method for displaying presentation contents shown in FIG. 3, which has been described hereinbefore and will not repeat herein.

In conclusion, the present invention proposes a presentation system, a receiver device, and methods thereof, wherein the sender side transmits screen frames to the receiver side, and wherein the receiver side stores the screen frames as web pages, and wherein a webpage server is established in the receiver side. The audiences attending the presentation can use the common browsers of mobile Internet devices or other network devices to link with the webpage server of the receiver side and browse the web pages containing the presentation contents without installing extra software. In a video teleconference, the audiences not only can use the video teleconference system to view the countenance and motion of the speaker but also can use the available network devices (such as computers) to link with the webpage server and browse the presentation contents.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A presentation system comprising:
a sender device including:
a capture module configured for capturing lossless screen frames from said sender device undertaking a presentation through a software program; and
a first communication interface electrically connecting with said capture module and configured for transmitting said screen frames; and
a receiver device including:
a second communication interface configured for receiving said screen frames;
a video connection port configured for electrically connecting with a display device, wherein said screen frames are output to said display device through said video connection port to display said screen frames for audiences;
a webpage server established in said receiver device and configured for storing said screen frames in a static picture format as web pages; and
a network interface electrically connecting with said webpage server, wherein a browser is linked to said webpage server through said network interface for browsing said web pages, wherein said first communication interface, said second communication interface and said network interface abide by wireless local area network.

2. The presentation system according to claim 1, wherein said sender device further determines whether said screen frame is used as said web page.

3. The presentation system according to claim 1, wherein said sender device periodically transmits said screen frames, or aperiodically transmits said screen frames that are static, or detects whether said screen frames change and transmits said screen frames that have been changed to said receiver device.

4. The presentation system according to claim 1, wherein said sender device further includes an encoding module electrically connecting between said capture module and said first communication interface and configured for encoding said lossless screen frames captured by said capture module.

5. The presentation system according to claim 1, wherein said webpage server includes an automatic refresh module configured for automatically refreshing said web pages browsed by said browser.

6. The presentation system according to claim 1, wherein the screen frames received from several said sender devices are integrated as one split screen frame to display on said display device and store as said web page.

7. The presentation system according to claim 1, wherein said receiver device is built in said display device or coupled to said display device in a detachable way.

8. The presentation system according to claim 1, wherein said video connection port is a VGA (Video Graphic Array) port, DVI (Digital Visual Interface), or HDMI (High Definition Multimedia Interface).

9. A receiver device, which cooperates with a sender device to form a presentation system, wherein said sender device captures lossless screen frames from said sender device undertaking a presentation through a software program and transmits said screen frames to said receiver device, and wherein said receiver device comprises:
a communication interface configured for receiving said screen frames transmitted by said sender device;
a video connection port configured for electrically connecting with a display device, wherein said screen frames are output to said display device through said video connection port;
a webpage server established in said receiver device and configured for storing said screen frames in a static picture format as web pages; and
a network interface electrically connecting with said webpage server, wherein a browser is linked to said webpage server through said network interface for browsing said web pages, wherein said communication interface and said network interface abide by wireless local area network.

10. The receiver device according to claim 9, wherein said webpage server includes an automatic refresh module configured for automatically refreshing said web pages browsed by said browser.

11. The receiver device according to claim 9, wherein the screen frames received from several said sender devices are integrated as one split screen frame to display on said display device and store as said web page.

12. The receiver device according to claim 9, wherein said receiver device is built in said display device or coupled to said display device in a detachable way.

13. The receiver device according to claim 9, wherein said video connection port is a VGA (Video Graphic Array) port, DVI (Digital Visual Interface), or HDMI (High Definition Multimedia Interface).

14. A presentation method comprising:
a sender device capturing lossless screen frames from said sender device undertaking a presentation through a software program and transmitting said screen frames to a receiver device, wherein said sender device and said receiver device abide by wireless local area network;
said receiver device receiving said screen frames and outputting said screen frames to a display device for displaying said screen frames;
establishing a webpage server in said receiver device; and
said receiver device storing said screen frames in a static picture format as web pages, which are to be browsed by a browser linked to said webpage server.

15. The presentation method according to claim 14, wherein said sender device further determines whether said screen frames is used as said web page.

16. The presentation method according to claim 14, wherein said sender device periodically transmits said screen frames, or aperiodically transmits said screen frames that are static, or detects whether said screen frames change and transmits said screen frames that have been changed to said receiver device.

17. The presentation method according to claim 14, wherein said sender device encodes said lossless screen frames captured by said sender device and transmits said screen frames that have been encoded.

18. The presentation method according to claim 14 further comprising: said webpage server automatically refreshing said web pages browsed by said browser.

19. The presentation method according to claim 14, wherein the screen frames received from several said sender devices are integrated as one split screen frame to display on said display device and store as said web page.

20. The presentation method according to claim 14, wherein said receiver device is built in said display device or coupled to said display device in a detachable way.

21. The presentation method according to claim 14, wherein said receiver device is linked with said display device through a VGA (Video Graphic Array) port, DVI (Digital Visual Interface), or HDMI (High Definition Multimedia Interface).

22. A method for displaying presentation contents, comprising:
a receiver device receiving screen frames captured by a sender device from said sender device undertaking a presentation through a software program and outputting said screen frames to a display device for displaying said screen frames for audiences;
establishing a webpage server in said receiver device; and
said receiver device storing said screen frames in a static picture format as web pages, which are to be browsed by a browser linked to said webpage server.

23. The method for displaying presentation contents according to claim 22 further comprising: said webpage server automatically refreshing said web pages browsed by said browser.

24. A non-transitory computer-readable medium, which stores a computer program that is loaded into a receiver device to execute a method for displaying presentation contents, wherein said method for displaying presentation contents comprises:
a receiver device receiving screen frames captured by a software program of a sender device from said sender device undertaking a presentation and outputting said screen frames to a display device for displaying said screen frames for audiences;
establishing a webpage server in said receiver device; and
said receiver device storing said screen frames in a static picture format as web pages, which are to be browsed by a browser linked to said webpage server.

25. The non-transitory computer-readable medium according to claim 24, wherein said method for displaying presentation contents further comprises: said webpage server automatically refreshing said web pages browsed by said browser.
